(19) United States
(12) Patent Application Publication
(10) Pub. No.: US 2018/0260847 A1
(43) Pub. Date: Sep. 13, 2018

(54) INFORMATION DISPLAY METHOD, APPARATUS, AND SYSTEM

(71) Applicant: Tencent Technology (Shenzhen) Company Limited, Shenzhen (CN)

(72) Inventors: Bin Zhou, Shenzhen (CN); Chunjian Ren, Shenzhen (CN)

(21) Appl. No.: 15/976,675

(22) Filed: May 10, 2018

Related U.S. Application Data
(63) Continuation-in-part of application No. PCT/CN2017/074085, filed on Feb. 20, 2017.

(30) Foreign Application Priority Data
Feb. 19, 2016 (CN) 201610094556.0

(51) Int. Cl. G06Q 30/02; H04L 29/08

(52) U.S. Cl. CPC G06Q 30/0255; H04L 67/42; H04L 67/306

(57) ABSTRACT

The embodiments of this application disclose an information display method performed at a computer server. After receiving a first display information request that is sent by a terminal and that corresponds to a target account, the computer server returns multiple display information options matching the target account to the terminal. After receiving a first display information option that is sent by the terminal and that is selected by a user from the multiple display information options, the computer server sends first display information corresponding to the first display information option to the terminal. After receiving a second display information request that is sent by the terminal and that corresponds to the target account, the computer server sends second display information to the terminal according to first type information of the first display information. The second display information has the first type information of the first display information.

### PRIORITY CLAIM AND RELATED APPLICATION

This application is a continuation-in-part application of PCT/CN2017/074085, entitled “METHOD, APPARATUS AND SYSTEM FOR PERFORMING INFORMATION PRESENTATION” filed on Feb. 20, 2017, which claims priority to Chinese Patent Application No. 201610094556.0, filed with the State Intellectual Property Office of the People's Republic of China on Feb. 19, 2016, and entitled “METHOD, APPARATUS AND SYSTEM FOR PERFORMING INFORMATION PRESENTATION”, all of which are incorporated herein by reference in their entirety.

### FIELD OF THE TECHNOLOGY

This application relates to the computer technology field, and in particular, to an information display method, apparatus, and system.

### BACKGROUND OF THE DISCLOSURE

As computer technologies and network technologies are developed, content of network videos becomes increasingly diverse. Because of diverse content, network videos gradually attract wide attention of users. When a user views a network video on a terminal, a server of a network video service may push display information such as news information and advertisement information to the terminal.

Preset display information of particular duration is usually presented immediately after playing of a network video is ended, and the display information is generally referred to as a post-roll advertisement.

### SUMMARY

To resolve the problem in the existing technology, embodiments of this application provide an information display method, apparatus, and system.

Embodiments of this application provide an information display method performed at a computer server having one or more processors and memory storing instructions to be executed by the one or more processors, including:
receiving a first display information request that is sent by a terminal and that corresponds to a target account, the first display information request being used to obtain display information presented after playing of a video is completed;
in response to the first display information request, returning multiple display information options to the terminal, wherein the multiple display information options are chosen to match the target account;
receiving a first display information option that is sent by the terminal and that is selected by a user from the multiple display information options, and sending first display information corresponding to the first display information option to the terminal, so that the terminal presents the first display information to the user after playing of the video is completed;
receiving a second display information request that is sent by the terminal and that corresponds to the target account, wherein the second display information request is generated in response to a user selection of the first display information at the terminal; and
   in response to the second display information request, sending second display information to the terminal according to first type information of the first display information, wherein the second display information has the first type information of the first display information

Embodiments of this application further provide a computer server includes one or more processors, memory, and a plurality of instructions stored in the memory that, when executed by the one or more processors, cause the computer server to perform the aforementioned method.

Embodiments of this application further provide a non-transitory computer readable storage medium storing a plurality of instructions configured for execution by a computer server having one or more processors, the plurality of instructions causing the computer server to perform the aforementioned method.

In the embodiments of this application, to-be-presented information selected by the user may be played, and to-be-presented information that the user may be interested in may be presented to the user based on to-be-presented information previously viewed by the user, thereby improving a pushing effect of to-be-presented information.

### BRIEF DESCRIPTION OF THE DRAWINGS

To describe the technical solutions in embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a flowchart of an information display method according to an embodiment of this application;

FIG. 2 is a schematic diagram of an information display interface according to an embodiment of this application;

FIG. 3 is a schematic diagram of an information display interface according to an embodiment of this application;

FIG. 4 is a flowchart of an information display method according to an embodiment of this application;

FIG. 5 is a schematic structural diagram of a server according to an embodiment of this application;

FIG. 6 is a schematic structural diagram of a server according to an embodiment of this application;

FIG. 7 is a schematic structural diagram of a server according to an embodiment of this application;

FIG. 8 is a schematic structural diagram of a terminal according to an embodiment of this application;

FIG. 9 is a schematic structural diagram of a terminal according to an embodiment of this application;

FIG. 10 is a schematic structural diagram of a server according to an embodiment of this application; and

FIG. 11 is a schematic structural diagram of a terminal according to an embodiment of this application.

### DESCRIPTION OF EMBODIMENTS

To make the objectives, technical solutions, and advantages of this application clearer, the following further describes the embodiments of this application in detail with reference to the accompanying drawings.

Embodiments of this application provide an information display method, and the method may be jointly implemented by a terminal and a server. The terminal may be a terminal with a video playing capability that is used by a user. The terminal may be installed with a video application program for playing a video. The terminal may be a smartphone, a computer, and the like. The terminal may be provided with a processor, a memory, a transceiver, and the like. The processor may be configured to process an information display procedure in a network video playing procedure. The memory may be configured to store required data and generated data in a processing process, and the transceiver may be configured to receive and send information. The terminal may be further provided with an input/output device such as a screen. The screen may be configured to display an application program interface, a video picture, and the like. The screen may be a touch control screen. The terminal may play a network video by using a video application program, or play a network video by accessing a video website. The server may be a backend server of a video application program for playing a video. The server may be provided with a processor, a memory, a transceiver, and the like. The processor may be configured to process an information display procedure in a network video playing procedure. The memory may be configured to store required data and generated data in a processing process. The transceiver may be configured to receive and send information. Display information is information actively pushed to a user by a server, and may be, for example, news information and advertisement information. In the embodiments of this application, for example, the terminal is a mobile phone and the display information is advertisement information of a commodity, to describe the solutions in detail. Other cases are similar to this, and are not described again in detail in the embodiments.

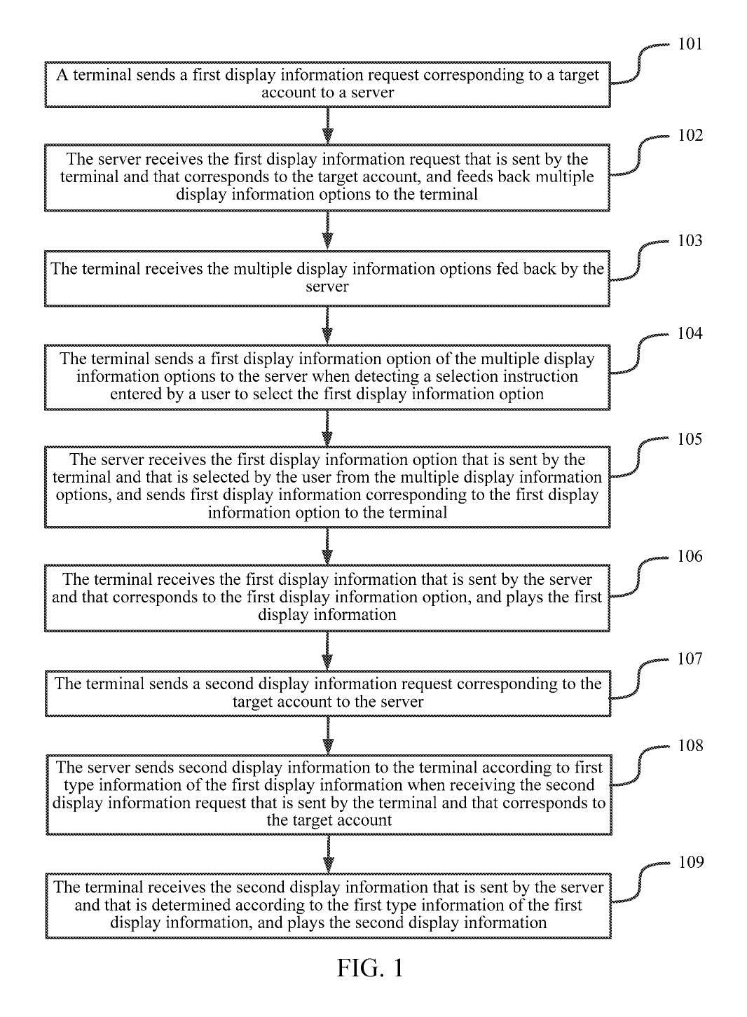

As shown in FIG. 1, a processing procedure of this method performed at a computer server may include the following steps:

Step 101: A terminal sends a first display information request corresponding to a target account to a server.

In this specification, “first” and “second” are merely intended to conveniently indicate two objects, and indicate no actual meanings. For example, a display information request herein is referred to as a first display information request only to be distinguished from a display information request sent by the terminal again below.

The display information request is a request used to obtain display information presented (that is, information used as a post-roll advertisement of a video) to a user after playing of the video is completed. The terminal may send the display information request to the server in various opportunities. For example, the terminal may send the display information request to the server before playing a video, in a process of playing a video, or after playing of a video is completed.

For example, a user may install a video application program on the terminal. After the video application program is triggered and enabled, and the target account is used to log into the video application program, a video list is extended to watch a movie. Within preset duration that lasts before playing of the movie is completed (the preset duration may be set by a technical person and stored in the server), the terminal may send the first display information request to the server, where the first display information request carries an account identifier of the target account. The account identifier of the target account may be a user account (for example, a user name, an email address, a phone number, an instant messaging account, or a social system account registered in a video playing system), or may be a device identifier (for example, a device hardware identity code, a phone number, an IP address, or an application identifier) of a terminal device used by a user. The application identifier is an identifier that can distinguish an application installed in a user equipment from a same application installed in another user equipment.

Step 102: The server receives the first display information request that is sent by the terminal and that corresponds to the target account, and returns multiple display information options to the terminal.

Herein, the display information option is information about display information or a display information type. For example, the display information option may be a title, a brief text introduction, a picture, or the like of display information, for example, a name or a picture of a car of a particular model or a name or a picture of a skin care product. Alternatively, the display information option may be a name, a picture, or the like of a display information type, for example, the name may be “car”, “cosmetics”, and “mother and infant products”. In some embodiments, the multiple display information options are chosen to match the target account. For example, the target account may have a user profile that includes one or more attributes characterizing the user of the target account. When the computer server determines which display information options to be returned to the requesting terminal, the computer server may check the video being or to be played to the user at the terminal and other videos that have been played to the user in the past and how the user interacts with the videos when they were played in the past, e.g., whether the play of a video was paused at a certain location, whether a video was replayed, and whether a video was aborted in the middle of the play, etc. Such information is used for screening the video content corresponding to the multiple display information options in light of the user profile. Those options with higher ranks are chosen for the target account and then returned to the requesting terminal. By doing so, the most relevant information is returned to the requesting terminal. This approach can significantly increase the likelihood of a user selecting one of the multiple display information options because they are presented to the user in the most intuitive manner.

In some examples, the server receives the first display information request that is sent by the terminal and that corresponds to the target account, and then sends, according to the account identifier of the target account, the multiple display information options to the terminal on which login is performed by using the target account. For example, the server may send three display information options to the terminal.

Step 103: The terminal receives the multiple display information options fed back by the server.

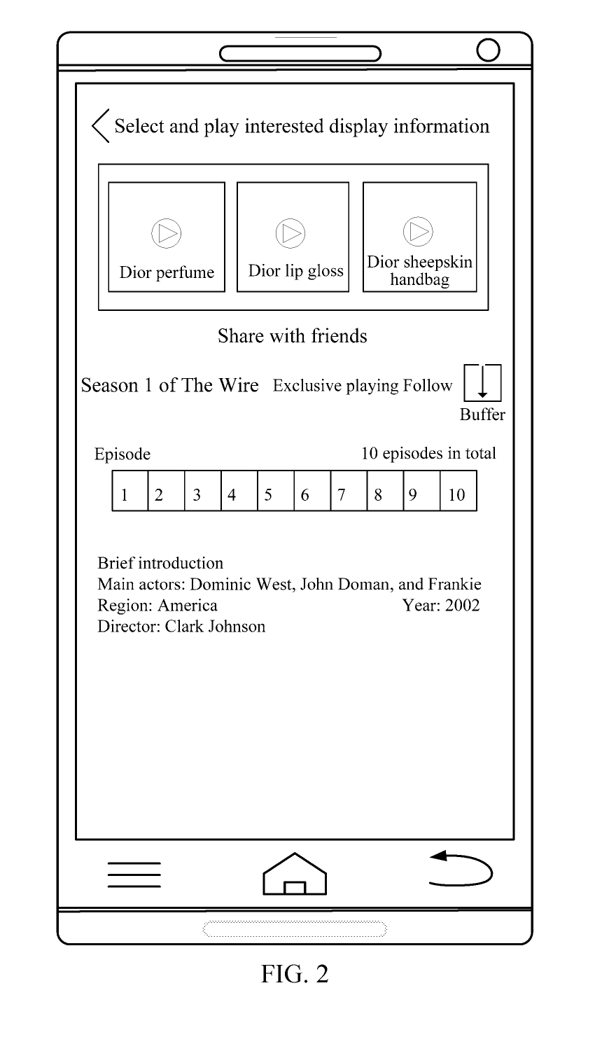

In the embodiments, after the terminal receives the multiple display information options fed back by the server, the terminal may display the multiple display information options on an interface. For example, as shown in FIG. 2, after the terminal receives three display information options fed back by the server, the terminal may display the three display information options of a Dior perfume option, a Dior lip gloss option, and a Dior sheepskin handbag option on an interface. In some embodiments, the three display information options are ordered from left to right by their respective relevance to the target account because a user is assumed to pay more attention to the leftmost item. In some embodiments, the three display information options may not have the same dimension. For example, the display information option having the highest relevance to the target account may be given the most prominent position on the screen of the terminal. In some embodiments, the most prominent position on the screen of the terminal is chosen based on the user's past behavior of interacting with the play of videos on the screen as well as the multiple display information options.

Step 104: The terminal sends a first display information option of the multiple display information options to the server when detecting a selection instruction entered by a user to select the first display information option.

In the embodiments, the terminal displays the multiple display information options on the interface, the user may click on the first display information option of the multiple display information options, and when the terminal detects the selection instruction entered by the user to select the first display information option, the terminal may send the first display information option to the server.

Step 105: The server receives the first display information option that is sent by the terminal and that is selected by the user from the multiple display information options, and sends first display information corresponding to the first display information option to the terminal.

In the embodiments, a technical person may preset a correspondence between a display information option and corresponding display information, and store the correspondence between a display information option and corresponding display information in the server. When the server receives the first display information option sent by the terminal, the server may determine, according to the correspondence between a display information option and display information, the first display information corresponding to the first display information option, and then send the first display information to the terminal, so that the terminal presents the first display information to the user after playing of the video is completed.

For example, when the display information option is information about display information, the server may provide the display information corresponding to the display information option to the terminal. When the display information option is information about a display information type, the server may determine display information in multiple pieces of display information of the display information type as the first display information, and provide the first display information to the terminal. In a method for determining display information in multiple pieces of display information as the first display information, display information may be randomly selected, or may be determined according to other parameters. For example, display information may be determined according to a preset priority of each display information and a quantity of times each display information has been presented, or according to a difference between a preset target quantity of times each display information is to be presented and a current quantity of times each display information has been presented, that is, a quantity of pushing times that are still required currently.

Moreover, the server may further store a correspondence between the target account and a display information type of the first display information. In some examples, when a display information request corresponding to the target account is received subsequently, multiple display information options may be determined according to the display information type corresponding to the target account, and provided to the terminal. In some examples, when a display information request corresponding to the target account is received subsequently, second display information may be determined according to the display information type corresponding to the target account, and provided to the terminal, so that the terminal presents the second display information to the user after playing of the video is completed. For example, after receiving the display information request, the server may detect whether the correspondence between the target account and the display information type is stored; if not, perform step 102 to return the multiple display information options to the terminal; if yes, skip step 102, determine the second display information according to the display information type corresponding to the target account, and provide the second display information to the terminal. The server may further set an aging time for the correspondence, and when the aging time reaches, the server may delete the correspondence.

Step 106: The terminal receives the first display information that is sent by the server and that corresponds to the first display information option, and plays the first display information.

In the embodiments, after the terminal receives the first display information sent by the server, the terminal may play the first display information on the interface.

Step 107: The terminal sends a second display information request corresponding to the target account to the server.

In the embodiments, when the user uses the target account to log into a video application program of the terminal to watch a video (for example, a myth movie), the terminal may send the second display information request to the server within preset duration (for example, 10 seconds) that lasts before playing of the video is completed, where the second display information request carries an account identifier of the target account.

Step 108: The server sends second display information to the terminal according to first type information of the first display information after receiving the second display information request that is sent by the terminal and that corresponds to the target account. In some embodiments, the second display information is chosen because it also has the first type information of the first display information. For example, when the second display information request is generated by the terminal after the presentation of the first display information at the terminal has been completed. In this case, it can be inferred that the user might be interested in the first type information of the first display information for not interrupting the presentation of such information. Therefore, the server then chooses the second display information that has the same type as the first display information based on the assumption that the user is interested in the second display information as well.

According to the embodiments, after playing of the video is completed, instead of playing pushing content specified by a service provider, pushing content autonomously selected by the user is played. Therefore, the user may be interested in the pushing content. In this way, after playing of the video is completed, the user may not directly close a playing interface, and is more likely to view to-be-presented information attached after the video, so that a display information pushing effect is better.

In the embodiments, when the server receives the second display information request that is sent by the terminal and that corresponds to the target account, the server may obtain the first display information corresponding to the target account, obtain the corresponding first type information according to the first display information, determine, according to the first type information, the second display information corresponding to the first type information, and then send the second display information to the terminal.

In the embodiments, the server may send the second display information corresponding to the second display information option selected by the user to the terminal. Corresponding processing may be: after receiving the second display information request that is sent by the terminal and that corresponds to the target account, the server determines multiple display information options that conform to the first type information of the first display information, and send the multiple display information options that conform to the first type information to the terminal; receive the second display information option that is sent by the terminal and that is selected by the user from the multiple display information options that conform to the first type information, and send the second display information corresponding to the second display information option to the terminal.

In the embodiments, a technical person may preset a correspondence between display information type information and a display information option, add each display information and corresponding type information to the correspondence, and store the correspondence in the server. After the server receives the second display information request sent by the terminal, the server may obtain the first type information corresponding to the first display information, obtain, according to the correspondence between type information and a display information option, the multiple display information options corresponding to the first type information, and then send the multiple display information options to the terminal. After the terminal receives the multiple display information options, the terminal may display the multiple display information options on the interface. The user may click on the second display information option of the multiple display information options, and trigger the terminal to receive the selection instruction of the second display information option. The terminal may send the second display information option to the server. After the server receives the second display information option, the server may obtain, according to the correspondence between a display information option and display information, the second display information corresponding to the second display information option, and then send the second display information to the terminal.

In the embodiments, the server may send a display information option that matches a login location of the terminal and that conforms to the first type information to the terminal. Corresponding processing may be: after receiving the second display information request that is sent by the terminal and that corresponds to the target account, the server obtains a login location of the target account; determines multiple display information options that are in a corresponding preset display area and that match the login location and conform to the first type information of the first display information, and send the multiple display information options to the terminal.

In the embodiments, a technical person may set a playing area for each display information (for example, the display information A is played in Beijing, and the display information B is played in Shanghai), and store the area in the server. When the server receives the second display information request that is sent by the terminal and that corresponds to the target account, the server may obtain the login location of the target account, determine the first type information of the first display information, determine the multiple display information options that match the login location of the target account and that conform to the first type information, and then send the multiple display information options to the terminal. For example, when the server receives the second display information request sent by the terminal, the server determines that the login location of the target account is Beijing, and the first type information corresponding to the first display information option is Dior perfume. The server may obtain multiple display information options of Dior perfume that may be played in Beijing, and then send the multiple display information options to the terminal.

In the embodiments, the server may send the display information played for a maximum quantity of times to the terminal. Corresponding processing may be: obtaining, from display information corresponding to the multiple display information options, preset display information played for a maximum quantity of times, and sending the preset display information played for a maximum quantity of times to the terminal if no display information option that is sent by the terminal and that is selected by the user from the multiple display information options is received within first preset duration that lasts after the multiple display information options that conform to the first type information are sent to the terminal.

In the embodiments, a technical person may preset the first preset duration, and store the first preset duration in the server. The first preset duration may be used, so that if no display information option sent by the terminal is received within the first preset duration that lasts after the server sends the multiple display information options that conform to the first type information to the terminal, the server sends display information played for a maximum quantity of times to the terminal. A technical person may set a quantity of times each display information is played, and store the quantity of times each display information is played in the server.

When the server sends the multiple display information options that conform to the first type information to the terminal, timing starts. If no selection instruction that is sent by the terminal to select a display information option of the multiple display information options is received after the subsequent first preset duration, the server may obtain the display information option that is of the multiple display information options sent to the terminal and that is played for a maximum quantity of times, then determine, according to the correspondence between a display information option and display information, display information corresponding to the display information option played for a maximum quantity of times, and send the display information to the terminal.

In the embodiments, if no type selection request sent by the terminal is received before the second display information request that is sent by the terminal and that corresponds to the target account is received, the second display information is sent to the terminal according to the first type information of the first display information when the second display information request that is sent by the terminal and that corresponds to the target account is received. If a type selection request sent by the terminal is received before the second display information request that is sent by the terminal and that corresponds to the target account is received, the second display information is sent to the terminal according to third type information when the second display information request that is sent by the terminal and that corresponds to the target account is received. The type selection request carries the third type information selected by the user

In the embodiments, if the server receives, before the server receives the second display information request that is sent by the terminal and that corresponds to the target account, no type selection request corresponding to the target account, after receiving the second display information request that is sent by the terminal and that corresponds to the target account, the server may determine that type information of the first display information is the first type information, then determine, according to the correspondence between type information and a display information option, the second display information option corresponding to the first type information, determine the second display information corresponding to the second display information option, and send the second display information to the terminal.

When the user uses a video application program to watch a video, the user may click on a setting option, to trigger the terminal to display a type setting option, a collection option, and some other options of display information. The user may click on the type setting option, to trigger to display multiple type options. The user may click on a selection box of the third type information, and then click on a determining key, to trigger the terminal to send the type selection request to the server, where the type selection request carries the third type information and the target account. When the server receives the type selection request, the server stores the target account and the corresponding third type information. When the server receives the second display information request, the server may perform parsing to obtain the target account carried, learn that type information corresponding to the target account is the third type information, determine, according to the correspondence between type information and a display information option, the second display information option corresponding to the third type information, determine the second display information corresponding to the second display information option, and send the second display information to the terminal.

In the embodiments, the server may send default display information to the terminal within an option rejection period. Corresponding processing may be: if an option rejection request sent by the terminal is received, obtaining, from default display information corresponding to preset various type information, the second display information corresponding to the first type information of the first display information, and sending the second display information to the terminal when the second display information request that is sent by the terminal and that corresponds to the target account is received in an option rejection period to which a time at which the option rejection request is received belongs.

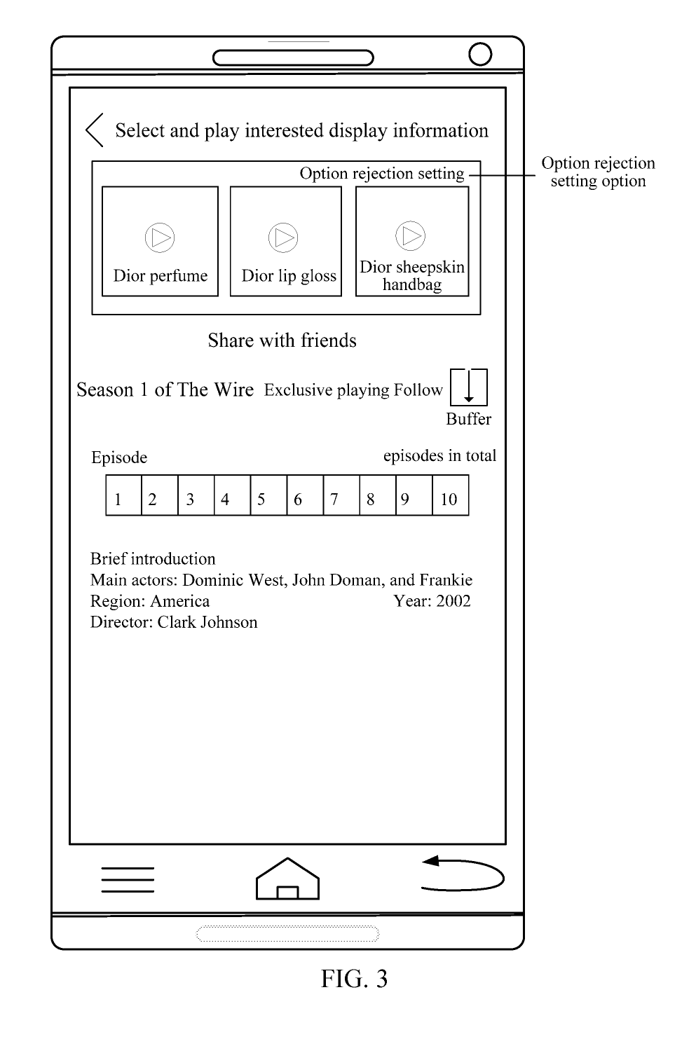

In the embodiments, when the user uses a video application program of the terminal to watch a video, after playing of the video is completed, the interface displays an option rejection setting option. The user may click on the option rejection setting option, to trigger the terminal to display multiple option rejection period options. The user may click on a selection box of an option rejection period option, to select an option rejection period to trigger the terminal to send the option rejection request to the server. The option rejection request carries the option rejection period. When the server receives the option rejection request, the server may perform parsing to obtain the option rejection period, and store the option rejection period as an option rejection period of the target account. When the server receives the second display information request sent by the terminal, the server may obtain the account identifier of the target account carried, obtain the option rejection period of the target account, and determine the first type information of the first display information within the option rejection period of the target account. Then, the server may determine, according to type information and corresponding default display information, the second display information corresponding to the first type information, and send the second display information to the terminal. For example, as shown in FIG. 3, after the user completes watching “the first episode of the first season of The Wire”, the interface displays an option rejection setting option. The user may click on the option rejection setting option, to trigger to display options of option rejection periods of one day, three days, seven days, and the like. If the user does not want to select a display information option for seven days, the user may click on a selection box of the option rejection period of seven days, to trigger the terminal to send an option rejection request carrying the option rejection period of seven days to the server. The server may store the option rejection period of seven days of the target account. When the server receives the second display information request, the server may obtain the option rejection period of the target account. If the server may determine the first type information of the first display information as female coat within seven days, the server may obtain, from the default display information of the first type information, the second display information corresponding to female coat as the display information of female coat, and send the display information of female coat to the terminal.

Step 109: The terminal receives the second display information that is sent by the server and that is determined according to the first type information of the first display information, and plays the second display information.

In the embodiments, after the terminal receives the second display information sent by the server, the terminal may play the second display information on the interface.

In the embodiments, the multiple display information options that are sent by the server and that conform to the first type information are received; when the selection instruction that is entered by the user to select the second display information option of the multiple display information options that conform to the first type information is detected, the second display information option is sent to the server; and the second display information that is sent by the server and that corresponds to the second display information option is received, and the second display information is played.

In the embodiments, after the terminal receives the multiple display information options that are sent by the server and that conform to the first type information, the terminal displays the multiple display information options on the interface. The user may click on the second display information option, to trigger the terminal to send the second display information option to the server. After the server receives the second display information option, the server may determine, according to the correspondence between a display information option and display information, the second display information corresponding to the second display information option, and then send the second display information to the server. After the terminal receives the second display information, the terminal plays the second display information.

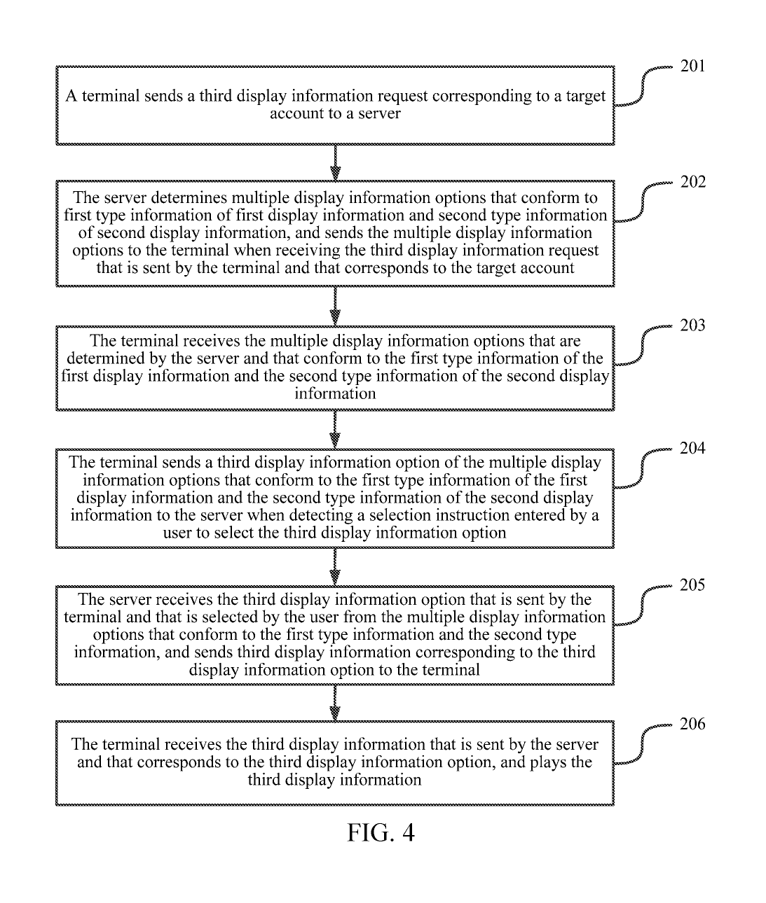

In the embodiments of this application, the server may further push the multiple display information options to the user according to the first type information and second type information, for selection by the user. As shown in FIG. 4, corresponding processing may be as follows:

Step 201: A terminal sends a third display information request corresponding to a target account to a server.

In the embodiments, the user uses the target account to log into a video application program of the terminal to watch a video. Within second preset duration that lasts before playing of the video is completed, the terminal may send a third display information request to the server, where the third display information request carries an account identifier of the target account.

Step 202: The server determines multiple display information options that conform to first type information of first display information and second type information of second display information, and sends the multiple display information options to the terminal when receiving the third display information request that is sent by the terminal and that corresponds to the target account.

In the embodiments, when the server receives the third display information request, the server may obtain type information of the first display information as the first type information and type information of the second display information as the second type information, then determine the multiple display information options that conform to the first type information and the second type information, and send the multiple display information options to the terminal.

Step 203: The terminal receives the multiple display information options that are determined by the server and that conform to the first type information of the first display information and the second type information of the second display information.

Step 204: The terminal sends a third display information option of the multiple display information options that conform to the first type information of the first display information and the second type information of the second display information to the server when detecting a selection instruction entered by a user to select the third display information option.

In the embodiments, after the terminal receives the multiple display information options, the terminal may display the multiple display information options on the interface. The user may click on the third display information option, to trigger the terminal to send the third display information option to the server.

Step 205: The server receives the third display information option that is sent by the terminal and that is selected by the user from the multiple display information options that conform to the first type information and the second type information, and sends third display information corresponding to the third display information option to the terminal.

In the embodiments, after the server receives the third display information option sent by the terminal, the server may determine, according to the correspondence between a display information option and display information, the third display information corresponding to the third display information option, and then send the third display information to the terminal.

Step 206: The terminal receives the third display information that is sent by the server and that corresponds to the third display information option, and plays the third display information.

In the embodiments, when the terminal receives the third display information sent by the server, the terminal may play the third display information on the interface.

In this embodiment of this application, the terminal sends the first display information request corresponding to the target account to the server. The server receives the first display information request that is sent by the terminal and that corresponds to the target account, and returns the multiple display information options to the terminal. The terminal receives the multiple display information options fed back by the server. When the terminal detects the selection instruction that is entered by the user to select the first display information option of the multiple display information options, the terminal sends the first display information option to the server. The server receives the first display information option that is sent by the terminal and that is selected by the user from the multiple display information options, and sends the first display information corresponding to the first display information option to the terminal. The terminal receives the first display information that is sent by the server and that corresponding to the first display information option, and plays the first display information. The terminal sends the second display information request corresponding to the target account to the server. When the server receives the second display information request that is sent by the terminal and that corresponds to the target account, the server sends the second display information to the terminal according to the first type information of the first display information. The terminal receives the second display information that is sent by the server and that is determined according to the first type information of the first display information, and plays the second display information. In this way, display information that conforms to a requirement of the user may be presented to the user according to display information previously viewed by the user, thereby improving effectiveness of the display information.

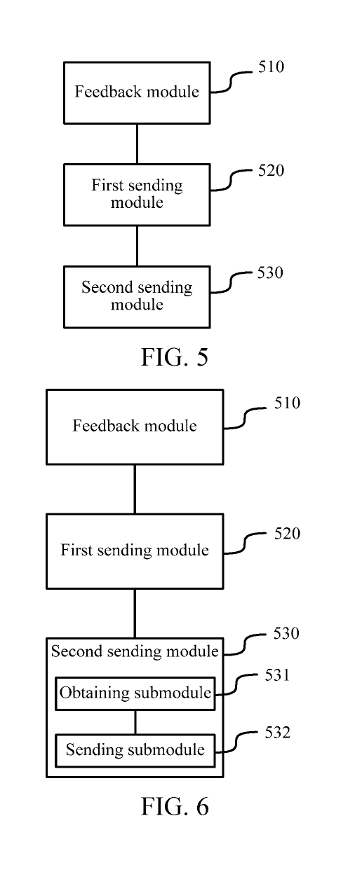

Based on the same technical idea, the embodiments of this application further provide a server. As shown in FIG. 5, the server includes a feedback module 510, configured to: receive a first display information request that is sent by a terminal and that corresponds to a target account, and feedback multiple display information options to the terminal;
a first sending module 520, configured to receive a first display information option that is sent by the terminal and that is selected by a user from the multiple display information options, and send first display information corresponding to the first display information option to the terminal; and
a second sending module 530, configured to send second display information to the terminal according to first type information of the first display information when receiving a second display information request that is sent by the terminal and that corresponds to the target account.

In the embodiments, the second sending module 530 is configured to determine multiple display information options that conform to the first type information of the first display information, and send the multiple display information options that conform to the first type information to the terminal after receiving the second display information request that is sent by the terminal and that corresponds to the target account; and
receive a second display information option that is sent by the terminal and that is selected by the user from the multiple display information options that conform to the first type information, and send the second display information corresponding to the second display information option to the terminal.

In the embodiments, as shown in FIG. 6, the second sending module 530 includes an obtaining submodule 531 and a sending submodule 532, where
the obtaining submodule 531 is configured to obtain a login location of the target account after receiving the second display information request that is sent by the terminal and that corresponds to the target account; and
the sending submodule 532 is configured to: determine the multiple display information options that are in a corresponding preset display area and that match the login location and conform to the first type information of the first display information, and send the multiple display information options to the terminal.

In the embodiments, the first sending module 520 is further configured to:
obtain, from display information corresponding to the multiple display information options, preset display information played for a maximum quantity of times, and send the preset display information played for a maximum quantity of times to the terminal if no display information option that is sent by the terminal and that is selected by the user from the multiple display information options is received within first preset duration that lasts after the multiple display information options that conform to the first type information are sent to the terminal.

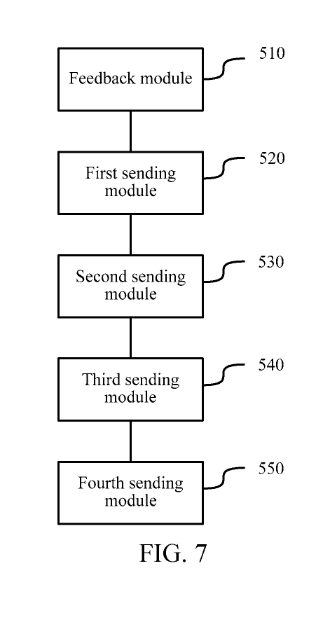

In the embodiments, as shown in FIG. 7, the server further includes:
a third sending module 540, configured to: determine multiple display information options that conform to the first type information of the first display information and second type information of the second display information, and send the multiple display information options to the terminal when receiving a third display information request that is sent by the terminal and that corresponds to the target account; and
a fourth sending module 550, configured to: receive a third display information option that is sent by the terminal and that is selected by the user from the multiple display information options that conform to the first type information and the second type information, and send third display information corresponding to the third display information option to the terminal.

In the embodiments, the second sending module 530 is configured to:
if no type selection request sent by the terminal is received before the second display information request that is sent by the terminal and that corresponds to the target account is received, send the second display information to the terminal according to the first type information of the first display information after receiving the second display information request that is sent by the terminal and that corresponds to the target account; and
the second sending module 530 is further configured to:
if a type selection request sent by the terminal is received before the second display information request that is sent by the terminal and that corresponds to the target account is received, send the second display information to the terminal according to third type information after receiving the second display information request that is sent by the terminal and that corresponds to the target account, where the type selection request carries the third type information selected by the user.

In the embodiments, the second sending module 530 is configured to:
if an option rejection request sent by the terminal is received, obtain, from default display information corresponding to preset various type information, the second display information corresponding to the first type information of the first display information, and send the second display information to the terminal when the second display information request that is sent by the terminal and that corresponds to the target account is received in an option rejection period to which a time at which the option rejection request is received belongs.

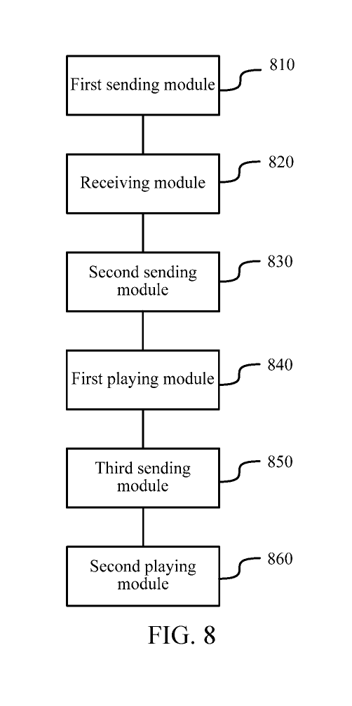

Based on the same technical idea, the embodiments of this application further provide a terminal. As shown in FIG. 8, the terminal includes:
a first sending module 810, configured to send a first display information request corresponding to a target account to a server;
a receiving module 820, configured to receive multiple display information options fed back by the server;
a second sending module 830, configured to send a first display information option of the multiple display information options to the server when detecting a selection instruction entered by a user to select the first display information option;
a first playing module 840, configured to: receive first display information that is sent by the server and that corresponds to the first display information option, and play the first display information;
a third sending module 850, configured to send a second display information request corresponding to the target account to the server; and
a second playing module 860, configured to: receive second display information that is sent by the server and that is determined according to the first type information of the first display information, and play the second display information.

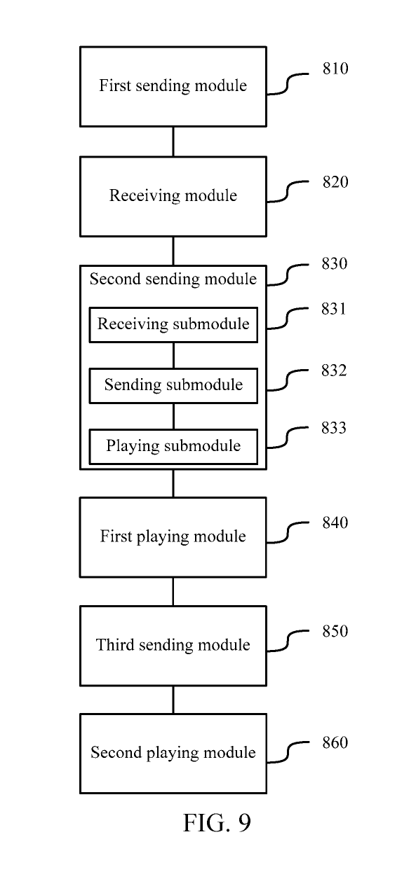

In the embodiments, as shown in FIG. 9, the second sending module 830 includes a receiving submodule 831, a sending submodule 832, and a playing submodule 833, where
the receiving submodule 831 is configured to receive multiple display information options that are sent by the server and that conform to the first type information of the first display information;
the sending submodule 832 is configured to send a second display information option of the multiple display information options that conform to the first type information to the server when detecting a selection instruction entered by the user to select the second display information option; and
the playing submodule 833 is configured to: receive the second display information that is sent by the server and that corresponds to the second display information option, and play the second display information.

In the embodiments, the first sending module 810 is further configured to:
send a third display information request corresponding to the target account to the server;
the receiving module 820 is further configured to receive multiple display information options that are sent by the server and that conform to the first type information of the first display information and second type information of the second display information;
the second sending module 830 is further configured to send a third display information option of the multiple display information options that conform to the first type information of the first display information and the second type information of the second display information to the server when detecting a selection instruction entered by the user to select the third display information option; and
the second playing module 860 is further configured to: receive third display information that is sent by the server and that corresponds to the third display information option, and play the third display information.

It should be noted that when the server and the terminal provided in the foregoing embodiments for displaying information display information, division of the functional modules is only used as an example for description. During actual application, the functions may be allocated to different functional modules for implementation according to requirements, that is, the internal structures of the server and the terminal are divided into different functional modules, to perform some or all of the functions described above. Moreover, the server and the terminal provided in the foregoing embodiments to display information and the embodiments of the information display method share a same idea. For a specific implementation process, refer to the method embodiments, and details are not described herein again.

In this embodiment of this application, the terminal sends the first display information request corresponding to the target account to the server. The server receives the first display information request that is sent by the terminal and that corresponds to the target account, and returns the multiple display information options to the terminal. The terminal receives the multiple display information options fed back by the server. When the terminal detects the selection instruction that is entered by the user to select the first display information option of the multiple display information options, the terminal sends the first display information option to the server. The server receives the first display information option that is sent by the terminal and that is selected by the user from the multiple display information options, and sends the first display information corresponding to the first display information option to the terminal. The terminal receives the first display information that is sent by the server and that corresponding to the first display information option, and plays the first display information. The terminal sends the second display information request corresponding to the target account to the server. When the server receives the second display information request that is sent by the terminal and that corresponds to the target account, the server sends the second display information to the terminal according to the first type information of the first display information. The terminal receives the second display information that is sent by the server and that is determined according to the first type information of the first display information, and plays the second display information. In this way, display information that conforms to a requirement of the user may be presented to the user according to display information previously viewed by the user, thereby improving effectiveness of the display information.

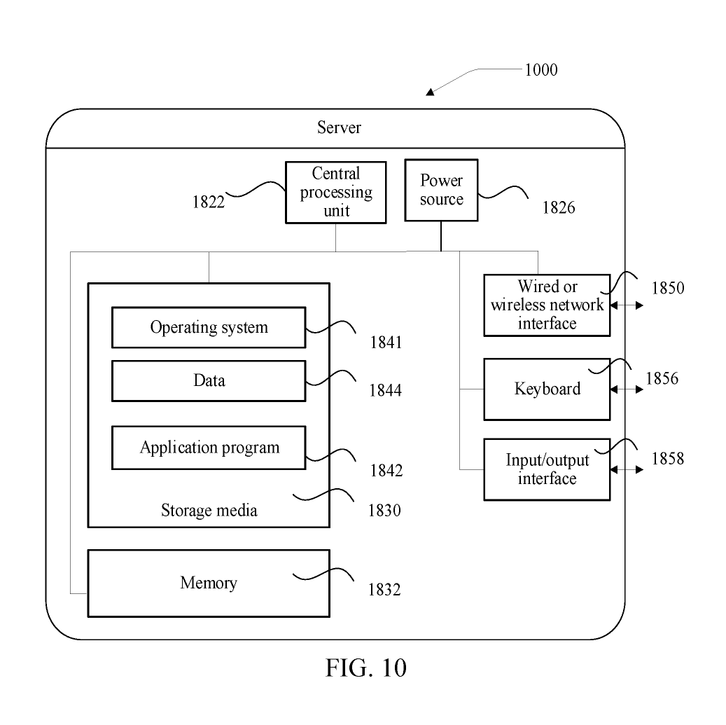

FIG. 10 is a schematic structural diagram of a server according to an embodiment of this application. The server 1000 may be greatly different according to different configurations or performance, and may include one or more central processing units (CPU) 1822 (for example, one or more processors), a memory 1832, and one or more storage media 1830 (for example, one or more mass storage devices) for storing an application program 1842 or data 1844. The memory 1832 and the storage medium 1830 may perform temporary storage or persistent storage. The program stored in the storage medium 1830 may include one or more modules (not marked in the figure), and each module may include a series of instruction operations in the server. Further, the central processing unit 1822 may be configured to communicate with the storage medium 1830, and execute, in the server 1000, a series of instruction operations in the storage medium 1830.

The server 1000 may further include one or more power sources 1826, one or more wired or wireless network interfaces 1850, one or more input/output interfaces 1858, one or more keyboards 1856, and/or one or more operating systems 1841 such as Windows Server™, Mac OS X™, Unix™, Linux™, and FreeBSD™.

The server 1000 may include a memory and one or more programs. The one or more programs are stored in the memory and configured to be executed by one or more processors. The one or more programs include instructions used to perform the following operations:
receiving a first display information request that is sent by a terminal and that corresponds to a target account, and returning multiple display information options to the terminal;
receiving a first display information option that is sent by the terminal and that is selected by a user from the multiple display information options, and sending first display information corresponding to the first display information option to the terminal; and
sending second display information to the terminal according to first type information of the first display information when receiving a second display information request that is sent by the terminal and that corresponds to the target account.

In the embodiments, the sending second display information to the terminal according to first type information of the first display information includes:
determining multiple display information options that conform to the first type information of the first display information, and sending the multiple display information options that conform to the first type information to the terminal after receiving the second display information request that is sent by the terminal and that corresponds to the target account; and
receiving a second display information option that is sent by the terminal and that is selected by the user from the multiple display information options that conform to the first type information, and sending the second display information corresponding to the second display information option to the terminal.

In the embodiments, the determining multiple display information options that conform to the first type information of the first display information, and sending the multiple display information options that conform to the first type information to the terminal after receiving the second display information request that is sent by the terminal and that corresponds to the target account includes:
obtaining a login location of the target account after receiving the second display information request that is sent by the terminal and that corresponds to the target account; and
determining the multiple display information options that are in a corresponding preset display area and that match the login location and conform to the first type information of the first display information, and sending the multiple display information options to the terminal.

In the embodiments, the method further includes:
obtaining, from display information corresponding to the multiple display information options, preset display information played for a maximum quantity of times, and sending the preset display information played for a maximum quantity of times to the terminal if no display information option that is sent by the terminal and that is selected by the user from the multiple display information options is received within first preset duration that lasts after the multiple display information options that conform to the first type information are sent to the terminal.

In the embodiments, the method further includes:
determining multiple display information options that conform to the first type information of the first display information and second type information of the second display information, and sending the multiple display information options to the terminal when receiving a third display information request that is sent by the terminal and that corresponds to the target account; and
receiving a third display information option that is sent by the terminal and that is selected by the user from the multiple display information options that conform to the first type information and the second type information, and sending third display information corresponding to the third display information option to the terminal.

In the embodiments, the sending the second display information to the terminal according to the first type information of the first display information after receiving the second display information request that is sent by the terminal and that corresponds to the target account includes:
if no type selection request sent by the terminal is received before the second display information request that is sent by the terminal and that corresponds to the target account is received, sending the second display information to the terminal according to the first type information of the first display information after receiving the second display information request that is sent by the terminal and that corresponds to the target account; and
the method further includes:
if a type selection request sent by the terminal is received before the second display information request that is sent by the terminal and that corresponds to the target account is received, sending the second display information to the terminal according to third type information after receiving the second display information request that is sent by the terminal and that corresponds to the target account, where the type selection request carries the third type information selected by the user.

In the embodiments, the sending the second display information to the terminal according to the first type information of the first display information after receiving the second display information request that is sent by the terminal and that corresponds to the target account includes:
if an option rejection request sent by the terminal is received, obtaining, from default display information corresponding to preset various type information, the second display information corresponding to the first type information of the first display information, and sending the second display information to the terminal when the second display information request that is sent by the terminal and that corresponds to the target account is received in an option rejection period to which a time at which the option rejection request is received belongs.

In this embodiment of this application, the terminal sends the first display information request corresponding to the target account to the server. The server receives the first display information request that is sent by the terminal and that corresponds to the target account, and returns the multiple display information options to the terminal. The terminal receives the multiple display information options fed back by the server. When the terminal detects the selection instruction that is entered by the user to select the first display information option of the multiple display information options, the terminal sends the first display information option to the server. The server receives the first display information option that is sent by the terminal and that is selected by the user from the multiple display information options, and sends the first display information corresponding to the first display information option to the terminal. The terminal receives the first display information that is sent by the server and that corresponding to the first display information option, and plays the first display information. The terminal sends the second display information request corresponding to the target account to the server. When the server receives the second display information request that is sent by the terminal and that corresponds to the target account, the server sends the second display information to the terminal according to the first type information of the first display information. The terminal receives the second display information that is sent by the server and that is determined according to the first type information of the first display information, and plays the second display information. In this way, display information that conforms to a requirement of the user may be presented to the user according to display information previously viewed by the user, thereby improving effectiveness of the display information.

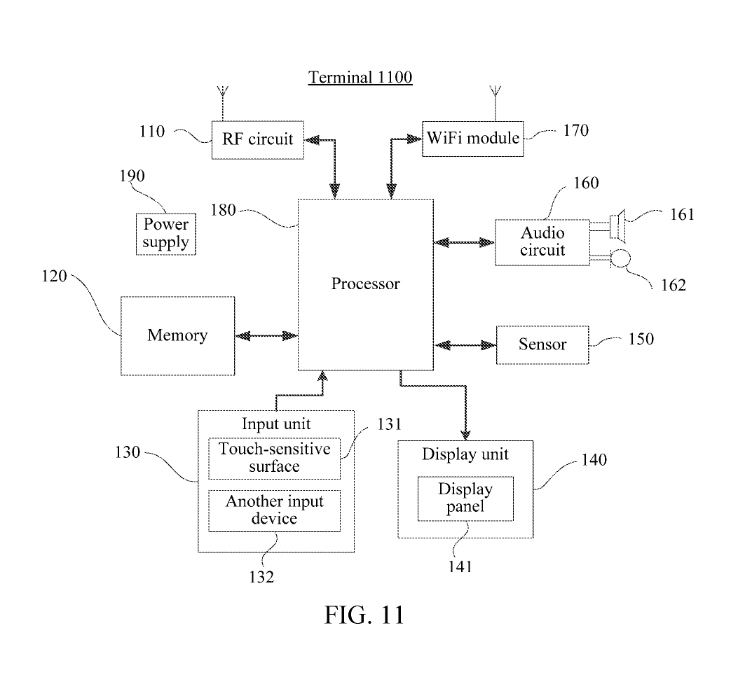

Referring to FIG. 11, FIG. 11 is a schematic structural diagram of a terminal according to an embodiment of this application. The terminal may be a smartphone, a tablet computer, or the like, and may be configured to implement the information display method provided in the foregoing embodiments. Details are as follows:
the terminal 1100 may include components such as a radio frequency (RF) circuit 110, a memory 120 including one or more computer readable storage media, an input unit 130, a display unit 140, a sensor 150, an audio circuit 160, a wireless fidelity (WiFi) module 170, a processor 180 including one or more processing cores, and a power supply 190. A person skilled in the art may understand that the structure of the terminal shown in FIG. 11 does not constitute a limitation on the terminal, and the terminal may include more or fewer components than those shown in the figure, or some components may be combined, or a different component deployment may be used.

The RF circuit 110 may be configured to receive and send a signal during an information receiving and sending process or a call process; and particularly receive downlink information from a base station, then deliver the downlink information to one or more processors 180 for processing, and send related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 110 may also communicate with a network and another device by means of wireless communication. The wireless communication may use any communications standard or protocol, which includes, but is not limited to, Global System for Mobile Communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playing function and an image display function), and the like. The data storage area may store data (such as audio data and an address book) created according to use of the terminal 1100, and the like. In addition, the memory 120 may include a high-speed random access memory, and may also include a non-volatile memory, such as at least one magnetic disk storage device, a flash memory device, or another volatile solid-state storage device. Accordingly, the memory 120 may further include a memory controller, so that the processor 180 and the input unit 130 access the memory 120.

The input unit 130 may be configured to receive inputted digit or character information, and generate keyboard, mouse, joystick, optical, or track ball signal input related to user setting and functional control. Specifically, the input unit 130 may include a touch-sensitive surface 131 and another input device 132. The touch-sensitive surface 131 may also be referred to as a touch screen or a touch panel, and may collect a touch operation of a user on or near the touch-sensitive surface (such as an operation of a user on or near the touch-sensitive surface 131 by using any suitable object or attachment, such as a finger or a stylus), and drive a corresponding connection apparatus according to a preset program. In the embodiments, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitive type, an infrared type, and a surface sound wave type. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information inputted by the user or information provided for the user, and various graphical user interfaces of the terminal 1100. The graphical user interfaces may be formed by a graph, text, an icon, a video, and any combination thereof. The display unit 140 may include a display panel 141. In the embodiments, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 11, the touch-sensitive surface 131 and the display panel 141 are used as two independent parts to implement input and output functions, in some embodiments, the touch-sensitive surface 131 and the display panel 141 may be integrated to implement the input and output functions.

The terminal 1100 may further include at least one sensor 150, for example, a light sensor, a motion sensor, or another sensor. Specifically, the light sensor may include an ambient light sensor and a proximity sensor. The ambient light sensor may adjust luminance of the display panel 141 according to brightness of the ambient light. The proximity sensor may switch off the display panel 141 and/or backlight when the terminal 1100 is moved to the ear. As one type of motion sensor, a gravity acceleration sensor may detect magnitude of accelerations in various directions (which generally are triaxial), may detect magnitude and a direction of the gravity when static, and may be configured to identify an application of a mobile phone gesture (such as switchover between a portrait mode and a landscape mode, a related game, and gesture calibration of a magnetometer), and a related function of vibration identification (such as a pedometer and a knock). Other sensors, such as a gyroscope, a barometer, a hygrometer, a thermometer, and an infrared sensor that may be configured in the terminal 1100 are not further described herein.

The audio circuit 160, a loudspeaker 161, and a microphone 162 may provide audio interfaces between the user and the terminal 1100. The audio circuit 160 may transmit an electrical signal obtained by converting received audio data to the loudspeaker 161, so that the loudspeaker 161 converts the electrical signal to a sound signal for outputting. In addition, the microphone 162 converts a collected sound signal to an electrical signal. The audio circuit 160 receives the electrical signal, converts the electrical signal to audio data, and outputs the audio data to the processor 180 for processing. The RF circuit 110 sends the audio data to, for example, another terminal, or outputs the audio data to the memory 120 for further processing. The audio circuit 160 may further include an earplug jack, so as to provide communication between a peripheral earphone and the terminal 1100.

WiFi belongs to a short distance wireless transmission technology. The terminal 1100 may help, by using the WiFi module 170, a user to receive and send an e-mail, browse a webpage, and access streaming media, and the like, which provides wireless broadband Internet access for the user. Though FIG. 11 shows the WiFi module 170, it can be understood that the WiFi module 170 is not necessarily a mandatory component of the terminal 1100, and may be omitted as needed without departing from the essence of this application.

The processor 180, as a control center of the terminal 1100, uses various interfaces and circuits to connect all parts of a mobile phone, and executes various functions of the terminal 1100 and processes data by operating or executing software programs and/or modules stored in the memory 120 and invoking data stored in the memory 120, so as to perform overall monitoring on the mobile phone. In the embodiments, the processor 180 may include one or more processing cores. Preferably, the processor 180 may integrate an application processor and a modem. The application processor mainly processes an operating system, a user interface, an application program, and the like. The modem mainly processes wireless communication. It may be understood that the foregoing modem may also not be integrated into the processor 180.

The terminal 1100 further includes the power supply 190 (such as a battery) for supplying power to the components. Preferably, the power supply may logically connect to the processor 180 by using a power supply management system, thereby implementing functions, such as charging, discharging, and power consumption management, by using the power supply management system. The power supply 190 may further include any component, such as one or more direct current or alternate current power supplies, a re-charging system, a power supply fault detection circuit, a power supply converter or an inverter, and a power supply state indicator.

Although not shown, the terminal 1100 may further include a camera, a Bluetooth module, and the like, which are not further described herein. Specifically, in this embodiment, the display unit of the terminal 1000 is a touch screen display, and the terminal 1000 further includes a memory and one or more programs. The one or more programs are stored in the memory and configured to be executed by one or more processors, and the one or more programs include instructions for performing the following operations:
sending a first display information request corresponding to a target account to a server;
receiving multiple display information options fed back by the server;
sending a first display information option of the multiple display information options to the server when detecting a selection instruction entered by a user to select the first display information option;
receiving first display information that is sent by the server and that corresponds to the first display information option, and playing the first display information;
sending a second display information request corresponding to the target account to the server; and
receiving second display information that is sent by the server and that is determined according to the first type information of the first display information, and playing the second display information.

In the embodiments, the receiving second display information that is sent by the server and that is determined according to the first type information of the first display information, and playing the second display information includes:
receiving multiple display information options that are sent by the server and that conform to the first type information of the first display information;
sending a second display information option of the multiple display information options that conform to the first type information to the server when detecting a selection instruction entered by the user to select the second display information option; and
receiving the second display information that is sent by the server and that corresponds to the second display information option, and playing the second display information.

In the embodiments, the method further includes:
sending a third display information request corresponding to the target account to the server;
receiving multiple display information options that are sent by the server and that conform to the first type information of the first display information and second type information of the second display information;
sending a third display information option of the multiple display information options that conform to the first type information of the first display information and the second type information of the second display information to the server when detecting a selection instruction entered by the user to select the third display information option; and
receiving third display information that is sent by the server and that corresponds to the third display information option, and playing the third display information.

In this embodiment of this application, the terminal sends the first display information request corresponding to the target account to the server. The server receives the first display information request that is sent by the terminal and that corresponds to the target account, and returns the multiple display information options to the terminal. The terminal receives the multiple display information options fed back by the server. When the terminal detects the selection instruction that is entered by the user to select the first display information option of the multiple display information options, the terminal sends the first display information option to the server. The server receives the first display information option that is sent by the terminal and that is selected by the user from the multiple display information options, and sends the first display information corresponding to the first display information option to the terminal. The terminal receives the first display information that is sent by the server and that corresponding to the first display information option, and plays the first display information. The terminal sends the second display information request corresponding to the target account to the server. When the server receives the second display information request that is sent by the terminal and that corresponds to the target account, the server sends the second display information to the terminal according to the first type information of the first display information. The terminal receives the second display information that is sent by the server and that is determined according to the first type information of the first display information, and plays the second display information. In this way, display information that conforms to a requirement of the user may be presented to the user according to display information previously viewed by the user, thereby improving effectiveness of the display information.

A person of ordinary skill in the art may understand that all or some of the steps of the foregoing embodiments may be implemented by using hardware, or may be implemented by a program instructing relevant hardware. The program may be stored in a computer-readable storage medium. The storage medium may be a read-only memory, a magnetic disk, an optical disc, or the like.

The foregoing describes only preferred embodiments of this application, and is not used to limit this application. Any modification, equivalent replacement, improvement, and the like made within the spirit and principle of this application shall fall within the protection scope of this application.

What is claimed is:

1. An information display method performed at a computer server having one or more processors and memory storing instructions to be executed by the one or more processors, the method comprising:
receiving a first display information request that is sent by a terminal and that corresponds to a target account, the first display information request being used to obtain display information presented after playing of a video is completed;
in response to the first display information request, returning multiple display information options to the terminal, wherein the multiple display information options are chosen to match the target account;
receiving a first display information option that is sent by the terminal and that is selected by a user from the multiple display information options, and sending first display information corresponding to the first display information option to the terminal, so that the terminal presents the first display information to the user after playing of the video is completed;
receiving a second display information request that is sent by the terminal and that corresponds to the target account, wherein the second display information request is generated in response to a user selection of the first display information at the terminal; and
in response to the second display information request, sending second display information to the terminal according to first type information of the first display information, wherein the second display information has the first type information of the first display information.

2. The method according to claim 1, wherein the sending second display information to the terminal according to first type information of the first display information comprises:
determining multiple display information options that conform to the first type information of the first display information, and sending the multiple display information options that conform to the first type information to the terminal after receiving the second display information request that is sent by the terminal and that corresponds to the target account; and
receiving a second display information option that is sent by the terminal and that is selected by the user from the multiple display information options that conform to the first type information, and sending the second display information corresponding to the second display information option to the terminal.

3. The method according to claim 2, wherein the determining multiple display information options that conform to the first type information of the first display information, and sending the multiple display information options that conform to the first type information to the terminal after receiving the second display information request that is sent by the terminal and that corresponds to the target account comprises:
obtaining a login location of the target account after receiving the second display information request that is sent by the terminal and that corresponds to the target account; and
determining the multiple display information options that are in a corresponding preset display area and that match the login location and conform to the first type information of the first display information, and sending the multiple display information options to the terminal.

4. The method according to claim 2, wherein the method further comprises:
obtaining, from display information corresponding to the multiple display information options, preset display information played for a maximum quantity of times, and sending the preset display information played for a maximum quantity of times to the terminal if no display information option that is sent by the terminal and that is selected by the user from the multiple display information options is received within first preset duration that lasts after the multiple display information options that conform to the first type information are sent to the terminal.

5. The method according to claim 2, wherein the method further comprises:
determining multiple display information options that conform to the first type information of the first display information and second type information of the second display information, and sending the multiple display information options to the terminal when receiving a third display information request that is sent by the terminal and that corresponds to the target account; and
receiving a third display information option that is sent by the terminal and that is selected by the user from the multiple display information options that conform to the first type information and the second type information, and sending third display information corresponding to the third display information option to the terminal.

6. The method according to claim 1, wherein the sending second display information to the terminal according to first type information of the first display information comprises:
if no type selection request sent by the terminal is received before the second display information request that is sent by the terminal and that corresponds to the target account is received, sending the second display information to the terminal according to the first type information of the first display information after receiving the second display information request that is sent by the terminal and that corresponds to the target account; and
the method further comprises:
if a type selection request sent by the terminal is received before the second display information request that is sent by the terminal and that corresponds to the target account is received, sending the second display information to the terminal according to third type information after receiving the second display information request that is sent by the terminal and that corresponds to the target account, wherein the type selection request carries the third type information selected by the user.

7. The method according to claim 1, wherein the sending second display information to the terminal according to first type information of the first display information comprises:
if an option rejection request sent by the terminal is received, obtaining, from default display information corresponding to preset various type information, the second display information corresponding to the first type information of the first display information, and sending the second display information to the terminal when the second display information request that is sent by the terminal and that corresponds to the target account is received in an option rejection period to which a time at which the option rejection request is received belongs.

8. A computer server comprising:
one or more processors;
memory; and
a plurality of instructions stored in the memory that, when executed by the one or more processors, cause the computer server to perform the following operations:
receiving a first display information request that is sent by a terminal and that corresponds to a target account, the first display information request being used to obtain display information presented after playing of a video is completed;
in response to the first display information request, returning multiple display information options to the terminal, wherein the multiple display information options are chosen to match the target account;
receiving a first display information option that is sent by the terminal and that is selected by a user from the multiple display information options, and sending first display information corresponding to the first display information option to the terminal, so that the terminal presents the first display information to the user after playing of the video is completed;
receiving a second display information request that is sent by the terminal and that corresponds to the target account, wherein the second display information request is generated in response to a user selection of the first display information at the terminal; and
in response to the second display information request, sending second display information to the terminal according to first type information of the first display information, wherein the second display information has the first type information of the first display information.

9. The computer server according to claim 8, wherein the operation of sending second display information to the terminal according to first type information of the first display information comprises:
determining multiple display information options that conform to the first type information of the first display information, and sending the multiple display information options that conform to the first type information to the terminal after receiving the second display information request that is sent by the terminal and that corresponds to the target account; and
receiving a second display information option that is sent by the terminal and that is selected by the user from the multiple display information options that conform to the first type information, and sending the second display information corresponding to the second display information option to the terminal.

10. The computer server according to claim 9, wherein the operation of determining multiple display information options that conform to the first type information of the first display information, and sending the multiple display information options that conform to the first type information to the terminal after receiving the second display information request that is sent by the terminal and that corresponds to the target account comprises:
obtaining a login location of the target account after receiving the second display information request that is sent by the terminal and that corresponds to the target account; and
determining the multiple display information options that are in a corresponding preset display area and that match the login location and conform to the first type information of the first display information, and sending the multiple display information options to the terminal.

11. The computer server according to claim 9, wherein the operations further comprise:
obtaining, from display information corresponding to the multiple display information options, preset display information played for a maximum quantity of times, and sending the preset display information played for a maximum quantity of times to the terminal if no display information option that is sent by the terminal and that is selected by the user from the multiple display information options is received within first preset duration that lasts after the multiple display information options that conform to the first type information are sent to the terminal.

12. The computer server according to claim 9, wherein the operations further comprise:
determining multiple display information options that conform to the first type information of the first display information and second type information of the second display information, and sending the multiple display information options to the terminal when receiving a third display information request that is sent by the terminal and that corresponds to the target account; and
receiving a third display information option that is sent by the terminal and that is selected by the user from the multiple display information options that conform to the first type information and the second type information, and sending third display information corresponding to the third display information option to the terminal.

13. The computer server according to claim 8, wherein the operation of sending second display information to the terminal according to first type information of the first display information comprises:
if no type selection request sent by the terminal is received before the second display information request that is sent by the terminal and that corresponds to the target account is received, sending the second display information to the terminal according to the first type information of the first display information after receiving the second display information request that is sent by the terminal and that corresponds to the target account; and
and the operations further comprise:
if a type selection request sent by the terminal is received before the second display information request that is sent by the terminal and that corresponds to the target account is received, sending the second display information to the terminal according to third type information after receiving the second display information request that is sent by the terminal and that corresponds to the target account, wherein the type selection request carries the third type information selected by the user.

14. The computer server according to claim 8, wherein the operation of sending second display information to the terminal according to first type information of the first display information comprises:
if an option rejection request sent by the terminal is received, obtaining, from default display information corresponding to preset various type information, the second display information corresponding to the first type information of the first display information, and sending the second display information to the terminal when the second display information request that is sent by the terminal and that corresponds to the target account is received in an option rejection period to which a time at which the option rejection request is received belongs.

15. A non-transitory computer readable storage medium storing a plurality of instructions configured for execution by a computer server having one or more processors, the plurality of instructions causing the computer server to perform the following operations:
receiving a first display information request that is sent by a terminal and that corresponds to a target account, the first display information request being used to obtain display information presented after playing of a video is completed;
in response to the first display information request, returning multiple display information options to the terminal, wherein the multiple display information options are chosen to match the target account;
receiving a first display information option that is sent by the terminal and that is selected by a user from the multiple display information options, and sending first display information corresponding to the first display information option to the terminal, so that the terminal presents the first display information to the user after playing of the video is completed;
receiving a second display information request that is sent by the terminal and that corresponds to the target account, wherein the second display information request is generated in response to a user selection of the first display information at the terminal; and
in response to the second display information request, sending second display information to the terminal according to first type information of the first display information, wherein the second display information has the first type information of the first display information.

16. The non-transitory computer readable storage medium according to claim 15, wherein the operation of sending second display information to the terminal according to first type information of the first display information comprises:
determining multiple display information options that conform to the first type information of the first display information, and sending the multiple display information options that conform to the first type information to the terminal after receiving the second display information request that is sent by the terminal and that corresponds to the target account; and
receiving a second display information option that is sent by the terminal and that is selected by the user from the multiple display information options that conform to the first type information, and sending the second display information corresponding to the second display information option to the terminal.

17. The non-transitory computer readable storage medium according to claim 16, wherein the operation of determining multiple display information options that conform to the first type information of the first display information, and sending the multiple display information options that conform to the first type information to the terminal after receiving the second display information request that is sent by the terminal and that corresponds to the target account comprises:
obtaining a login location of the target account after receiving the second display information request that is sent by the terminal and that corresponds to the target account; and
determining the multiple display information options that are in a corresponding preset display area and that match the login location and conform to the first type information of the first display information, and sending the multiple display information options to the terminal.

18. The non-transitory computer readable storage medium according to claim 16, wherein the operations further comprise:
obtaining, from display information corresponding to the multiple display information options, preset display information played for a maximum quantity of times, and sending the preset display information played for a maximum quantity of times to the terminal if no display information option that is sent by the terminal and that is selected by the user from the multiple display information options is received within first preset duration that lasts after the multiple display information options that conform to the first type information are sent to the terminal.

19. The non-transitory computer readable storage medium according to claim 16, wherein the operations further comprise:
determining multiple display information options that conform to the first type information of the first display information and second type information of the second display information, and sending the multiple display information options to the terminal when receiving a third display information request that is sent by the terminal and that corresponds to the target account; and
receiving a third display information option that is sent by the terminal and that is selected by the user from the multiple display information options that conform to the first type information and the second type information, and sending third display information corresponding to the third display information option to the terminal.

20. The non-transitory computer readable storage medium according to claim 15, wherein the operation of sending second display information to the terminal according to first type information of the first display information comprises:
if no type selection request sent by the terminal is received before the second display information request that is sent by the terminal and that corresponds to the target account is received, sending the second display information to the terminal according to the first type information of the first display information after receiving the second display information request that is sent by the terminal and that corresponds to the target account; and
and the operations further comprise:
if a type selection request sent by the terminal is received before the second display information request that is sent by the terminal and that corresponds to the target account is received, sending the second display information to the terminal according to third type information after receiving the second display information request that is sent by the terminal and that corresponds to the target account, wherein the type selection request carries the third type information selected by the user.
